(19) United States
(12) Patent Application Publication
(10) Pub. No.: US 2008/0199185 A1
(43) Pub. Date: Aug. 21, 2008

(54) METHOD AN APPARATUS FOR OBTAINING REAL-TIME MEASUREMENTS OF OPTICAL SIGNALS IN AN OPTICAL NETWORK WITH MINIMAL OR NO INTERRUPTIONS IN COMMUNICATIONS OVER THE NETWORK

(76) Inventors: Frederick W. MILLER, Santa Clara, CA (US); James Al Matthews, Milpitas, CA (US)

Correspondence Address: Kathy Manke;Avago Technologies Limited, 4380 Ziegler Road, Fort Collins, CO, 80525, US

(21) Appl. No.: 11/675,482

(22) Filed: Feb. 15, 2007

(51) Int. Cl. H04B 10/00

(52) U.S. Cl. 398/139

(57) ABSTRACT

High-speed measurements of the output power level of a laser are obtained by using a high-speed optical monitoring device that is capable of producing an electrical feedback signal having an amplitude that varies based on the amount of light impinging on the monitoring devices. These signals are processed and measured by OTDR circuitry and sampling circuitry within the transceiver module to allow measurements to be made in the transceiver module to detect breaks, defects or discontinuities in the transmit fiber, BER, mask margin, jitter, rise and fall times, logic 1 level, logic 0 level, crossing level of rise and fall times, double tracing anomalies, hits in the eye region, etc.

### TECHNICAL FIELD OF THE INVENTION

The invention relates to optical networks over which data is communicated in the form of optical signals transmitted and received over optical waveguides. More particularly, the invention relates to a method and an apparatus for taking optical signal measurements in real-time at a node of the network with minimal or no interruption in communications over the network and without having to insert and remove measurement equipment.

### BACKGROUND OF THE INVENTION

In optical communications networks, transceivers are used to transmit and receive optical signals over optical fibers. A laser of the transceiver generates amplitude modulated optical signals that represent data, which are then transmitted over an optical fiber coupled to the transceiver.

FIG. 1 illustrates a block diagram of a transceiver module 2 currently used in optical communications, which uses optical feedback to control the average output power level of the laser. The transceiver module 2 includes a transmitter portion 3 and a receiver portion 4. The transmitter and receiver portions 3 and 4 are controlled by a transceiver controller 6. The transmitter portion 3 includes a laser driver 11 and a laser diode 12. The laser driver 11 outputs electrical signals to the laser diode 12 to modulate the laser diode 12 to cause it to output optical signals that have power levels corresponding to logic 1s and logic 0s. An optics system (not shown) of the transceiver module 2 focuses the coherent light beams produced by the laser diode 12 into the end of a transmit optical fiber (not shown).

A low-speed monitor photodiode 14 monitors the output power levels of the laser diode 12 and produces respective electrical analog feedback signals that are delivered to an analog-to-digital converter (ADC) 15, which converts the electrical analog signals into electrical digital signals. The digital signals are input to the transceiver controller 6, which processes them to obtain the average output power level of the laser diode 12. The controller 6 outputs control signals to the laser driver 11 to cause it to adjust the bias current signal output to the laser diode 12 such that the average output power level of the laser diode 12 is maintained at a relatively constant level.

The receiver portion 4 includes a receive photodiode 21 that receives an incoming optical signal output from the end of a receive optical fiber (not shown). An optics system (not shown) of the receiver portion 4 focuses the light output from the end of the receive optical fiber onto the receive photodiode 21. The receive photodiode 21 converts the incoming optical signal into an electrical analog signal. An ADC 22 converts the electrical analog signal into an electrical digital signal suitable for processing by the transceiver controller 6. The transceiver controller 6 processes the digital signals to recover the data represented by the signals.

At times, it is desirable or necessary to obtain measurements relating to the optical signals produced by the laser other than, or in addition to, the average output power level of the laser. For example, a test commonly referred to as the bit error rate (BER) test is often performed in optical networks to determine the probability that a bit in the data stream is received in error. To perform the test, an error performance analyzer having a pseudo-random binary sequence (PRBS) pattern generator is inserted into the network. The pattern generator generates PRBS bit sequences that are used to amplitude modulate the laser diode 12 of the transceiver 2. An error detector located in the network receives the signals produced by the laser diode 12 and compares the received signals with the PRBS bit sequences to determine whether any bit errors have been detected. While the laser diode 12 is being modulated by the PRBS sequences, the transceiver 2 cannot be used to transmit actual data, and so communications over the network are interrupted.

BER tests are typically pass/fail in nature and do not convey much other useful information. For this and other reasons, a number of other types of measurements are often performed on the optical waveform in the time domain. To perform these time-domain measurements, an optical time-domain reflectometer (OTDR) is used. The OTDR is typically a component of an oscilloscope or of an eye diagram analyzer, and is often included as a component of the error performance analyzer used to perform the BER test. The pattern generator of the performance analyzer generates the PRBS sequences to modulate the laser diode 12 while the OTDR displays a digitized time-domain representation of the waveform on the display monitor. The displayed waveform is commonly referred to as an eye diagram. By viewing the eye diagram, the person performing the analysis can determine the likelihood that a receiver will mistake a logic 1 level for a logic 0 level, and vice versa. In general, the more open the eye is, the lower the likelihood that a receiver will mistake a logic 1 level for a logic 0 level, and vice versa. The waveform being measured is repetitively sampled by sampling circuitry of the OTDR. The samples are applied to the vertical input of the display monitor while the data rate is used to trigger the horizontal sweep of the display monitor. For several types of coding, the pattern looks like a series of eyes between a pair of rails, and hence the term “eye diagram” is commonly used to describe it.

It is known that the eye should have a particular shape in order to achieve a satisfactory BER. For this reason, masks have been constructed in and around the eye that mask off portions of the displayed waveform that fall within the masked regions. The size and shape of the eye mask varies depending on the bit rate of the data. For example, the mask for a lower bit rate may be a hexagon whereas the mask for a higher bit rate may be a rectangle. The OTDR can therefore be used to determine the amount by which a measured waveform extends into the eye region, which is commonly referred to as the mask margin.

OTDRs are also used to determine whether a break, defect or discontinuity in the fiber exists, and if so, the location of the break, defect or discontinuity. To test for this condition, the performance analyzer modulates the laser with a PRBS sequence to cause optical signals to be injected into the fiber. If a break, defect or discontinuity in the fiber exists, it will cause light to be reflected back to the transceiver. The OTDR then displays a time-domain representation of the reflected waveform and the transmitted waveform, and the relative time difference between the waveforms can be used to determine the distance of the break, defect or discontinuity from the transceiver.

The OTDR, like the BER error performance analyzer, must be inserted into and removed from the network for the measurements to be taken. Inserting the equipment into the network requires that the network be taken down, which is time consuming and burdensome. Likewise, removing the equipment after the measurements have been obtained and putting the network back up is also time consuming and burdensome. In addition, communications are disrupted during the entire process from the time the network is taken down until it is put back up, which of course is undesirable. Furthermore, the current approach to using an OTDR to locate a break in a fiber is reactive rather than proactive in that the test is typically only performed after a customer has called the network administrator and reported a problem. A technician then goes to the central office and disconnects the appropriate connectors from the appropriate transceiver and connects them to OTDR to perform the measurements.

It would desirable to provide an apparatus and method for performing the types of tests and measurements described above that does require the insertion of equipment into and removal of equipment from the network. It would also be desirable to provide such an apparatus and method with the ability to perform these tests and measurements with the least possible amount of interruption in communications over the network. It would also be desirable to provide such an apparatus and method that can be used to frequently and proactively perform an OTDR analysis for various purposes, including to detect fiber breaks, defects or discontinuities in any fiber of the network, as opposed to only performing an OTDR analysis to detect such a condition only after the condition has been reported by a customer.

### SUMMARY OF THE INVENTION

In accordance with the invention, a method and an apparatus are provided that enable a transceiver having optical time-domain reflectometer (OTDR) circuitry to perform one or more OTDR algorithms to evaluate, based on a high-speed amplitude measurement value obtained using high-speed monitoring, detection and measurement circuitry in the transceiver, one or more aspects of signal quality in the network.

Examples of signal measurements that may be obtained by the transceiver include measurements based on light reflected by a break, a defect or a discontinuity in the transmit fiber, which can be used to determine the distance of the condition from the transceiver. Other aspects of signal quality that may be evaluated include, for example, one or more of: bit error rate (BER), mask margin, jitter, rise and fall times, logic 1 level, logic 0 level, crossing level of rise and fall times, double tracing anomalies, hits in an eye region of an eye diagram, etc.

These and other features and advantages of the invention will become apparent from the following description, drawings and claims.

### BRIEF DESCRIPTION OF THE DRAWINGS

FIG. 1 illustrates a block diagram of a transceiver module 2 currently used in optical communications that uses optical feedback in the manner described above to control the PAVG level of the laser.

FIG. 2 illustrates a block diagram of the transceiver of the invention having high-speed monitoring, detection and measurement circuitry for detecting and measuring data rate speed signals, OTDR circuitry for performing OTDR analyses, sampling circuitry for generating an eye diagram, and an eye monitor for displaying the eye diagram.

FIG. 3 illustrates a flowchart that represents the method of the invention in accordance with an illustrative embodiment performed in a transceiver to perform an OTDR analysis to determine whether a break, defect or discontinuity exists in a fiber.

FIG. 4 illustrates a flowchart that represents the method of the invention in accordance with an illustrative embodiment performed in a transceiver to obtain one or more measurements relating to a signal transmitted and/or received by a transceiver.

### DETAILED DESCRIPTION OF AN ILLUSTRATIVE EMBODIMENT

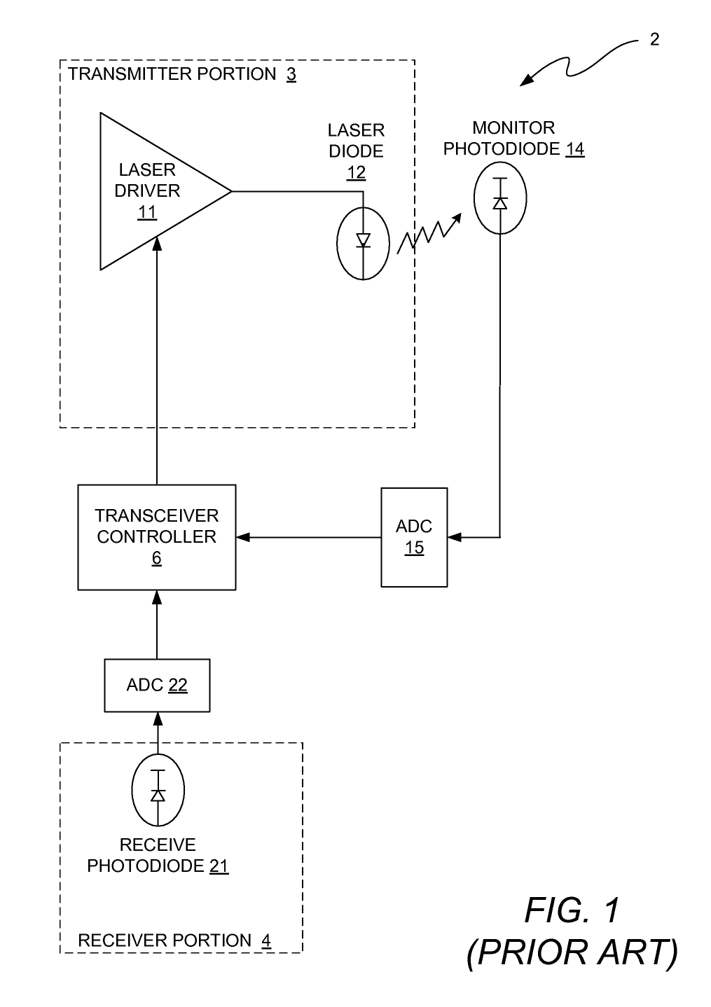

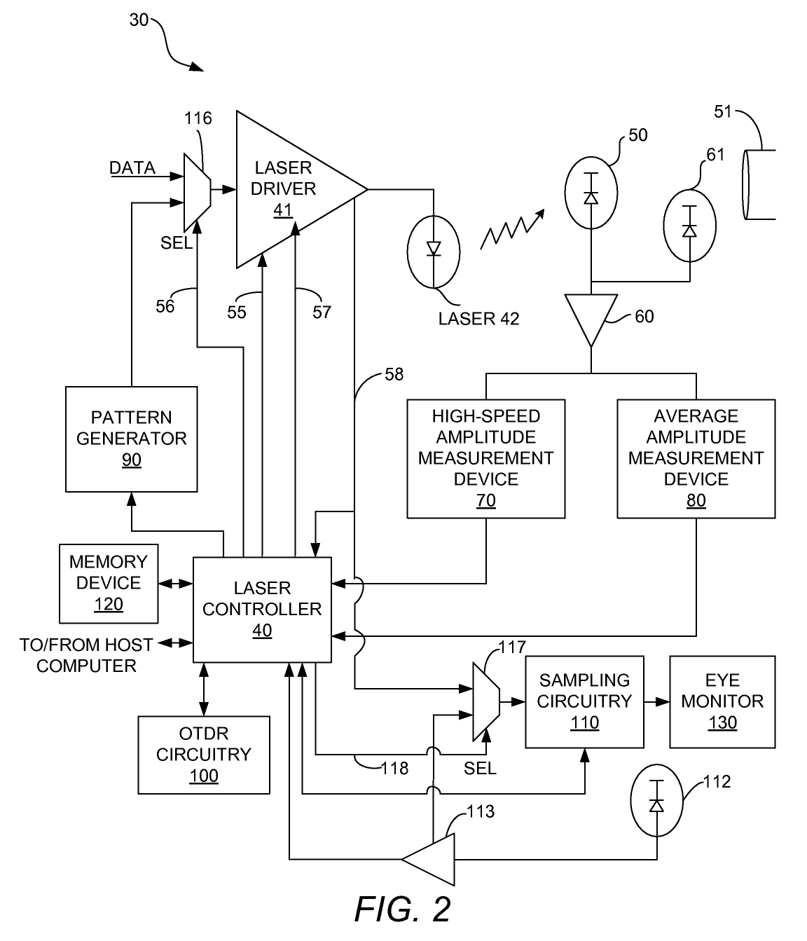

In accordance with the invention, the low-speed monitoring loop shown in FIG. 1 comprising the low-speed monitoring photodiode 14 and ADC 15 has been replaced with a high-speed monitoring loop comprising a high-speed optical detector and other circuitry capable of operating at data rate speed for obtaining real-time high-speed measurements of the output power level of the laser. When actual data is being transmitted, these measurements may be used to adjust the amplitudes of the laser modulation and/or bias currents to maintain the output power level of the laser at a desired level. When testing is to be performed to obtain signal measurements such as, for example, BER, mask margin, the location of a fiber break, extinction ratio, etc., the high-speed measurements are used to perform an OTDR analysis and other types of signal integrity analyses in real-time. These and other aspects of the invention will now be described with reference to FIGS. 2-4.

FIG. 2 illustrates a block diagram of the apparatus 30 of the invention in accordance with an illustrative embodiment. The apparatus 30 is typically implemented as a transceiver having transmitter and receiver components, optical feedback monitoring components, and signal test and measurement components. Therefore, the numeral 30 will be used interchangeably herein to denote “apparatus” and “transceiver”. The transmitter components and the optical feedback monitoring components of the apparatus 30 include a laser controller 40, a laser driver 41, a laser 42, a high-speed optical monitoring device 50, a high-speed amplitude detection device 60, a high-speed amplitude measurement device 70, and an average amplitude measurement device 80. The signal test and measurement components of the apparatus 30 include a pattern generator 90, OTDR circuitry 100, sampling circuitry 110, a memory device 120, and an eye display monitor 130. The receiver components of the apparatus 30 typically include a high-speed receive photodiode 112 and a high-speed amplitude detector 113. The high-speed monitoring photodiode 50 of the high-speed feedback loop is typically a high-speed photodiode, which may be identical to the high-speed receive photodiode 112.

The laser controller 40 and the laser driver 41 can be separate integrated circuit (ICs) that are mounted to a transceiver housing (not shown) of the transceiver 30 and electrically connected to one another. However, a single chip fully integrated solution provides significant signal integrity and cost advantages. The laser 42 is typically a laser diode, but may be any type of laser that is directly modulated. The high-speed optical monitoring device 50 is typically a high-bandwidth photodiode, but may be any type of device capable of monitoring the optical output power of the laser 42 and producing a signal having an amplitude that varies with variations in the laser output power level. The laser 42 and the monitoring device 50 are typically also implemented in separate ICs.

The high-speed device 60 is typically a high-speed trans-impedance amplifier (TIA). The high-speed amplitude measurement device 70 is an analog amplitude measurement device, such as a peak detector, for example. The high-speed amplitude measurement device 70 receives the amplified high-speed signal output from the TIA 60 and produces an amplitude measurement value. The amplitude measurement value is typically a value corresponding to the OMA of the laser 42, but could be some other value (e.g., a value corresponding to P1 or P0). The amplitude measurement value is converted by an analog-to-digital converter (ADC) (not shown) into a digital amplitude value, which is received by the controller 40. The ADC may be part of the measurement device 70 or it may be a separate component interposed between the output of the measurement device 70 and the input to the controller 40. If the ADC is a high-speed device capable of operating at speeds greater than the data rate of the transmitter, the output of the high-speed amplitude measurement device 70 could be monitored directly. Typically, if the ADC is not capable of operating at speeds greater than the data rate of the transmitter, the output of the high-speed amplitude measurement device 70 will typically be put through a lowpass filter device (integrating device) (not shown) before being input to the ADC for conversion from an analog voltage signal into a digital voltage signal. In the latter case, the lowpass filter device may be part of the measurement device 70 or it may be a separate component interposed between the output of the measurement device 70 and the input to the controller 40.

The apparatus 30 is configurable to be placed in a normal mode of operation in which actual data is being transmitted and in a diagnostic mode of operation in which OTDR testing is performed and measurements are obtained for performing OTDR-type analyses. In the normal mode of operation, the controller 40 asserts the select line 56, causing the multiplexer (MUX) 116 to select actual data as the input to the laser driver 41.

In order to perform an OTDR analysis to detect a break, a defect or a discontinuity in the transmit fiber (not shown), the controller 40 places the apparatus 30 in the diagnostic mode of operations by deasserting the select signal line 56, causing the MUX 116 to select the output of the pattern generator 90 as the input to the laser driver 41. The pattern generator 90 generates a test bit pattern, which preferably is a PRBS sequence of the type described above, and outputs it to the input of the MUX 116. The MUX 116 selects the test bit pattern and provides it to the input of the laser driver 41. The test bit pattern may be made up of a single bit or multiple bits. The laser driver 41 then causes the laser diode 42 to be amplitude modulated by the bit pattern to produce a corresponding optical signal, which is coupled by an optics system (not shown) into the end of a transmit fiber 51. After the laser diode 42 has been modulated with the test bit pattern, the laser diode 42 is turned off so that it is not transmitting any optical power. If the transmit fiber 51 contains a break, a defect or a discontinuity, a corresponding optical signal will be reflected back to the apparatus 30 by the break, defect or discontinuity and received by the high-speed monitoring photodiode 50.

For this embodiment, an optical coupling arrangement (not shown) is needed to ensure that light reflected along the transmit fiber 51 back to the transceiver 30 is coupled onto the high-speed monitoring photodiode 50. Since the laser diode 42 is not transmitting actual data during the test, the high-speed monitoring photodiode 50 can be used for this test. Alternatively, an additional high-speed photodiode 61, which is optional, could be used for this purpose, in which case light reflected along the transmit fiber 51 back to the transceiver 30 is coupled onto the additional high-speed photodiode 61 and not onto the high-speed monitoring photodiode 50.

The electrical signal produced by the monitoring photodiode 50 (or additional high-speed photodiode 61) is received by the high-speed amplitude detector 60, which detects the amplitude of the electrical signal and provides an amplitude detection signal to the high-speed amplitude measurement device 70. The high-speed amplitude measurement device 70 receives the detection signal and produces an amplitude measurement value, which is typically the OMA but may be some other amplitude measurement value (e.g., P0 or PI). The controller 40 receives the amplitude measurement value and stores it in a memory device 120, which may be internal or external to the controller 40. The controller 40 sends the amplitude measurement value to the OTDR circuitry 100, which executes a detection algorithm that determines whether a break, a defect or a discontinuity exists in the transmit fiber, and if so, the distance of the condition from the transceiver 30.

To determine whether such a condition exists, the OTDR circuitry 100 first determines whether the amplitude measurement value correlates to the test bit pattern. If so, the OTDR circuitry 100 then determines the distance of the break, defect or discontinuity from the transceiver 30. To do this, the OTDR circuitry 100 uses timing information received from the controller 40 relating to the time difference between the instant in time that the laser was modulated with the test bit pattern and the instant in time when the corresponding optical signal was detected by the monitoring photodiode 50. The OTDR circuitry processes this timing information along with the speed of light to compute the distance of the break, defect or discontinuity from the transceiver 30. The high-speed monitoring loop makes it possible to perform the OTDR analyses inside of the transceiver 30 because it is fast enough to detect light reflected back down the transmit fiber by a break, defect or discontinuity in the fiber. This is not possible with the low-speed monitoring loop described above with reference to FIG. 1. The OTDR circuitry 100 may be part of the controller 40 or it may be circuitry that is separate from the controller 100.

If a single pulse as opposed to a series of pulses is launched down the transmit fiber 51 to check for a defect, break or discontinuity, it is possible that other light on the transmit fiber 51 from elements on the network other than the laser 42 will interfere with the single pulse, which may affect the accuracy of the determination made by the OTDR circuitry 100. To overcome this type of problem, it may be desirable to use a bit pattern that is sufficiently unique that it does not repeat very often, at least not within the maximum period of time required for light launched into the transmit fiber 51 to be reflected by a defect, break or discontinuity in the fiber 51 back to the transceiver 30. Such a bit pattern may be generated by the pattern generator 90 or may be contained in the actual data stream. If the pattern generator 90 is used, communications are interrupted during the test, but only for a period of time long enough for the measurement to be performed to determine whether a break, defect or discontinuity exists. Thus, unlike the known technique used for this purpose, it is not necessary with the invention to interrupt communications in order to insert OTDR equipment into the network to perform the test. Consequently, communications are interrupted only for a period of time long enough to deassert signal line 116 in order to switch to the diagnostic mode of operations, perform the test, and then reassert the signal line 116 to return to the normal mode of operations. In addition, because equipment does not have to be inserted to perform the test, the test can be performed more often and with added convenience.

If the actual data stream is used to test for a break, a defect or a discontinuity in the transmit fiber 51, the controller 40 is configured to perform an algorithm that looks at the actual data stream being transmitted during the normal mode of operations (line 58) and detects if the laser driver 41 is using a unique bit pattern to modulate the laser diode 42. The unique bit pattern may be many bits in length (e.g., 16 bits) to reduce the probability that the data pattern will repeat within a short time period. If the controller 40 detects a unique bit pattern in the actual data by, for example, using a correlator inside of the controller 40, the controller 40 then causes a timer to start. The controller 40 then analyzes the amplitude measurement values output from the high-speed amplitude measurement device 70 for a period of time that is equal to or less than the maximum time period that would lapse before reflected light would be received by the photodiode 50 if a defect, break or discontinuity in fact existed. During this time period, the controller 40 uses the correlator to determine if reflected light corresponding to the unique bit pattern has been detected. If so, the controller 40 stops the timer and uses the timer value to compute the distance of the break, defect or discontinuity from the transceiver 30. If a reflection corresponding to the unique bit pattern is not detected during the time period, the controller 40 resets the time and begins looking for the next unique bit pattern to use to check for a break, defect or discontinuity in the transmit fiber 51. These tasks could instead be performed in the OTDR circuitry 100, or by the OTDR circuitry 100 in conjunction with the controller 40.

One of the benefits of using bit patterns contained in the actual data stream for this purpose is that communications do not have to be interrupted in order to perform the measurements. It would be necessary, however, to use the additional high-speed photodiode 61 and an optical directional coupler (not shown) to direct light reflected from the transmit fiber 51 away from the monitor photodiode 50 and onto the additional photodiode 61. Otherwise, the reflected light would interfere with the optical feedback from the laser diode 42 to the monitor photodiode 50. The electrical signal produced by this additional photodiode 61 would then be output to the high-speed amplitude detector 60 and processed in the manner described above by the measurement device 70 and the controller 40, or by the measurement device 70, the controller 40 and/or OTDR circuitry 100.

The controller 40 may be configured to automatically and periodically perform the test to check for breaks, defects or discontinuities in the transmit fiber. Alternatively, the controller 40 may be configured to communicate with a host computer (not shown) that instructs the controller 40 to perform the test.

Another aspect of the invention relates to using the sampling circuitry 110 to generate an eye diagram that is displayed on the eye monitor 130 to enable signal quality to be evaluated (e.g., BER, mask margin, jitter, rise and fall times, logic 1 level, logic 0 level, crossing level of rise and fall times, double tracing anomalies, hits in the eye region, etc.) The sampling circuitry 110 repetitively samples an incoming signal corresponding to either to the electrical signal used to modulate the laser diode 42 or the electrical signal output from the receive high-speed amplitude detector 113. The receive high-speed amplitude detector 113 is typically a trans-impedance amplifier of the type described above with respect to the high-speed detector 60. The controller 40 asserts the select signal 118 to cause the signal that the laser driver 41 will use to modulate the laser diode 42 to be connected to the input of the sampling circuitry 110. The controller 40 deasserts the select signal 118 to cause the signal that is generated by the amplitude detector 113 to be connected to the input of the sampling circuitry 110. The pattern generator 90 is typically used to generate test bit patterns for modulating the laser 42 in order to evaluate the quality of the signals being transmitted and/or received by the transceiver 30. Some of the signal quality measurements may be obtained while actual data is being transmitted and/or received.

As the sampling circuitry 110 samples the input signal, the samples are digitized and stored in memory, such as in the controller memory device 120 or in a memory element (not shown) within the sampling scope circuitry 110. The digitized samples are then read out of memory and applied to the vertical input terminal (not shown) of the eye monitor 130 while the data rate is used to trigger the horizontal sweep of the eye monitor 130. This generates an eye diagram that a person performing the measurements may view to assess signal quality, such as, for example, BER, mask margin, jitter, rise and fall times, logic 1 level, logic 0 level, crossing level of rise and fall times, double tracing anomalies, hits in the eye region, etc. The sampling circuitry 110 and eye monitor 130 may be similar or identical to the sampling circuitry and eye monitor commonly used in the aforementioned existing OTDR systems. The digitized samples stored in memory may also be read out by the controller 40 and provided to the host computer (not shown) to allow the host computer to perform diagnostics.

By providing the transceiver 30 with the capability to perform measurements of the type described above, it is no longer necessary to use expensive OTDR equipment for this purpose that must be inserted into the network to perform the diagnostics and then removed from the network after the diagnostics have been performed. In addition, each transceiver module may be configured with this capability to enable testing to be performed more easily, more frequently and at more locations within the network, resulting in better network maintenance, and consequently, in an overall improvement in the quality of communications over the network.

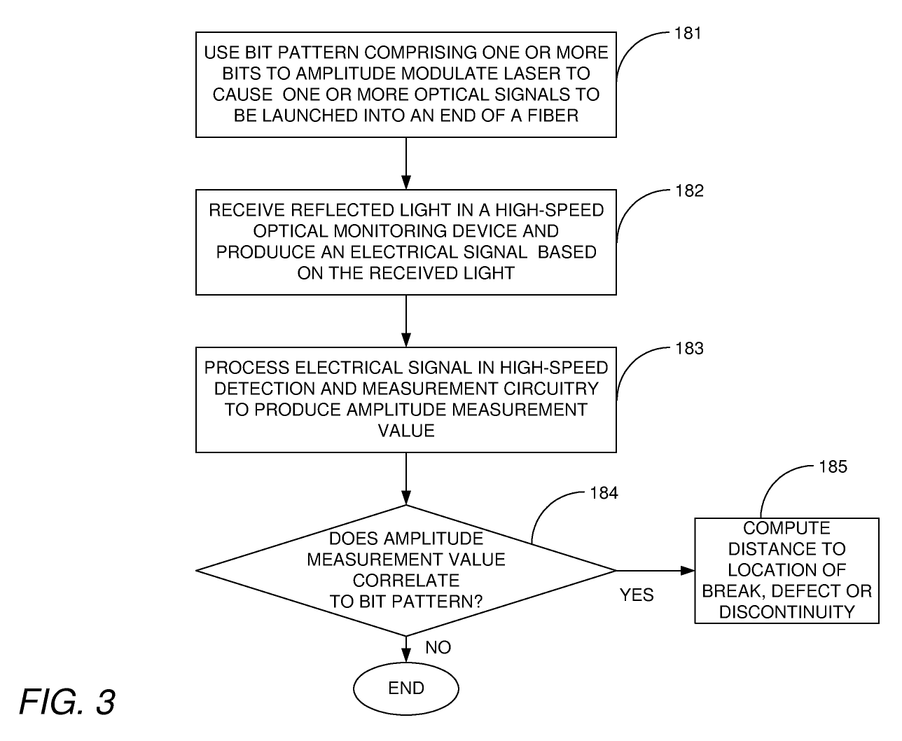

FIG. 3 illustrates a flowchart that represents the method of the invention in accordance with an illustrative embodiment performed in a transceiver to determine whether a break, defect or discontinuity exists in a fiber. A bit pattern comprising one or more bits is used to amplitude modulate a laser to cause one or more optical signals to be launched into an end of a fiber to be tested, as indicated by block 181. A high-speed optical monitoring device of the transceiver positioned to receive light reflected by a break, defect or discontinuity in the fiber produces an electrical signal based on light received by the monitoring device, as indicated by block 182. The electrical signal produced by the monitoring device is processed by high-speed amplitude detection and measurement circuitry of the transceiver to produce an amplitude measurement value, as indicated by block 183. The amplitude measurement value is processed by processing circuitry to determine whether the value correlates to the bit pattern used to modulate the laser, as indicated by block 184. If it is determined that the value does not correlate to the bit pattern, the process either ends. If it is determined that the value does correlate to the bit pattern, the processing circuitry determines that a break, defect or discontinuity in the fiber has been detected, and computes the distance to the break, defect or discontinuity, as indicated by block 185.

As described above with reference to FIG. 2, a single bit or multiple bits can be used for the test pattern, and the bit or bits may be a test bit or bits produced by a pattern generator or a test bit or bits in the actual data stream. In the case where the bit pattern is produced by a pattern generator, the transmission of actual data is typically halted while the test is being performed. In the case where the bit pattern is part of the actual data stream, actual data is transmitted while the test is being performed. In either case, it is unnecessary to insert test equipment into the network, and thus no interruption in communications results from the inserting test equipment into and removing test equipment from the network.

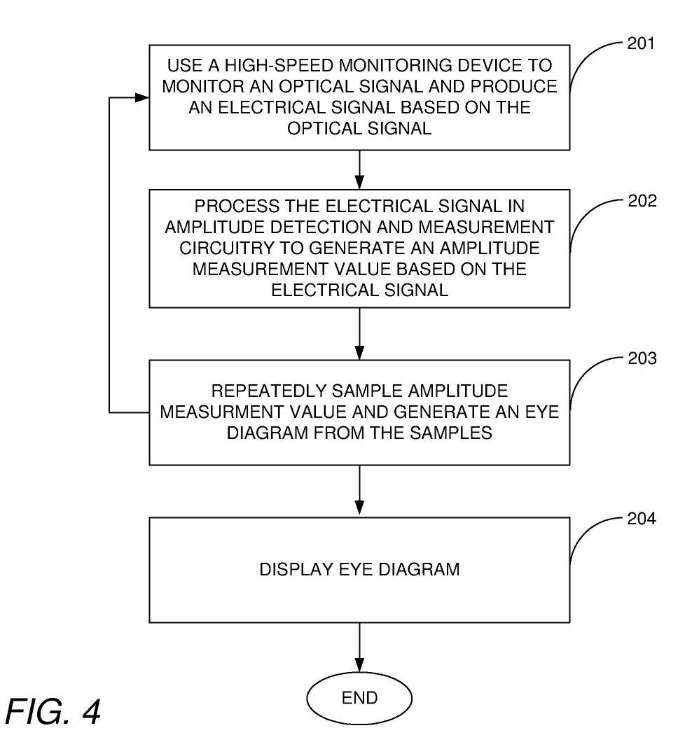

FIG. 4 illustrates a flowchart that represents the method of the invention in accordance with an illustrative embodiment performed in a transceiver to obtain one or more measurements relating to a signal transmitted and/or received by a transceiver. As described above with reference to FIG. 2, the transceiver of the invention is configured with circuitry that enables signal measurements to be taken, such as, for example, BER, mask margin, jitter, rise and fall times, logic 1 level, logic 0 level, crossing level of rise and fall times, double tracing anomalies, hits in the eye region, etc. These measurements are typically obtained by using the sampling circuitry of the transceiver to repeatedly sample an incoming waveform detected and measured by a high-speed monitoring, detecting and measuring circuitry.

A high-speed monitoring device of the transceiver receives an optical signal to be measured and produces an electrical signal based on the received optical signal, as indicated by block 201. High-speed amplitude detection and measurement circuitry of the transceiver then detects and measures the amplitude of the electrical signal and produce an amplitude measurement value that is based on the electrical signal, as indicated by block 202. High-speed sampling circuitry of the transceiver samples the amplitude measurement value repeatedly over time and generates an eye diagram from the samples, as indicated by block 203. To do this, the process represented by blocks 201-203 is repeated over time, i.e., it is recursive, as indicated by the arrow from block 203 to block 201. The eye diagram generated from the samples is then displayed on an eye monitor, as indicated by block 204.

As stated above, the person performing the test views the eye diagram on the eye monitor and is able to evaluate one or more of the signal quality measurements for BER, mask margin, jitter, rise and fall times, logic 1 level, logic 0 level, crossing level of rise and fall times, double tracing anomalies, hits in the eye region, etc. The waveform samples may also be forwarded to a host computer via the transceiver controller for evaluation at a remote location (e.g., the network headend).

The laser controller 40 may be any type of computational device capable of performing the processing tasks described above with reference to FIGS. 2-4. For example, the controller 40 may be a microprocessor, a microcontroller, an application specific integrated circuit (ASIC), a programmable logic array (PLA), a programmable gate array (PGA), a state machine, etc. The algorithms of the invention may be performed in hardware, software, firmware, or a combination thereof. If part or all of the algorithms are performed in software or firmware, the corresponding computer code will typically be stored in one or more computer-readable medium devices, such as memory device 120, which may be integrated together with the laser controller 40 in a single IC or which may be implemented in a separate IC.

Likewise, the OTDR circuitry 100 may be any type of computational device capable of performing the OTDR algorithms, including, for example, a microprocessor, a microcontroller, an application specific integrated circuit (ASIC), a programmable logic array (PLA), a programmable gate array (PGA), a state machine, etc. The OTDR algorithms of the invention may be performed in hardware, software, firmware, or a combination thereof. If part or all of the algorithms are performed in software or firmware, the corresponding computer code will typically be stored in one or more computer-readable medium devices, such as memory device 120, which may be integrated together with the laser controller 40 in a single IC or implemented in a separate IC.

The computer-readable medium need not be a solid state memory device, but may be any type of memory element that is suitable for the purpose for which it is used. Suitable memory devices include random access memory (RAM), read-only memory (ROM), programmable read-only memory (PROM), erasable PROM (EPROM), magnetic disks, magnetic tape, flash memory, etc. If all or a part of the algorithms are performed in hardware in the controller 40, the hardware may be implemented in the form of one or more state machines, for example.

It should be noted that the invention has been described with reference to a few illustrative embodiments for the purposes of demonstrating the principles and concepts of the invention and to provide a few examples of the manner in which the invention may be implemented. The invention is not limited to these embodiments, as will be understood by persons skilled in the art in view of the description provided herein. The invention also is not limited to being used in a communications transmitter, but may be used in any type of application including, for example, medical, industrial, printing, and defense applications. Those skilled in the art will understand that modifications may be made to the embodiments described herein and that all such modifications are within the scope of the invention.

What is claimed is:

1. An apparatus for measuring signals in a transceiver of an optical communications network, the apparatus comprising:
a laser capable of being modulated to produce light;
a laser driver that generates an electrical modulation signal based on one or more bits received by the laser driver, the laser driver modulating the laser with the electrical modulation signal to cause the laser to produce a modulated light beam that is launched into an end of a transmit fiber;
at least a first high-speed optical signal monitoring device that receives light impinging thereon and produces a first electrical signal based on the received light, at least a fraction of the received light corresponding to a portion of the light beam that has been reflected by a break, a defect or a discontinuity in the transmit fiber;
high-speed amplitude detection and measurement circuitry that receives the first electrical signal produced by the monitoring device and detects and measures the amplitude of the first electrical signal to produce a first amplitude measurement value;
laser controller circuitry that receives the first amplitude measurement value, the laser controller circuitry controlling at least the laser driver; and
optical time-domain reflectometer (OTDR) circuitry in communication with the laser controller circuitry, the OTDR circuitry performing one or more OTDR algorithms to evaluate, based on the first amplitude measurement value, one or more aspects of signal quality in the network.

2. The apparatus of claim 1, wherein one of said one or more OTDR algorithms includes a detection algorithm that processes the first amplitude measurement value to determine whether a break, a defect or a discontinuity exists in the transmit fiber, wherein if the OTDR circuitry determines that a break, defect or discontinuity exists, the OTDR circuitry determines the distance of the break, defect or discontinuity from the transceiver.

3. The apparatus of claim 2, wherein the apparatus further comprises:
a bit pattern generator, the pattern generator generating a test bit pattern comprising one or more bits, the test bit pattern being received by the laser driver and used by the laser driver to generate the electrical modulation signal that is used to modulate the laser.

4. The apparatus of claim 3, wherein the first high-speed optical signal monitoring device is a first high-speed monitoring photodiode capable of operating at a data rate of the transceiver.

5. The apparatus of claim 4, wherein the apparatus is capable of operating in a normal mode of operations and in a diagnostic mode of operations, and wherein in the normal mode of operations the first high-speed monitoring photodiode is used for receiving optical feedback from the laser and said one or more bits correspond to one or more bits of an actual data stream being transmitted by the transceiver, and wherein in the diagnostic mode of operations the first high-speed monitoring photodiode is used for receiving light reflected by a break, a defect or a discontinuity in the transmit fiber and said one or more bits correspond to one or more bits of a bit pattern generated by the bit pattern generator.

6. The apparatus of claim 4, further comprising:
a second high-speed optical signal monitoring device for receiving a fraction of the light produced by the laser as optical feedback and producing an electrical feedback signal, and wherein the high-speed amplitude detection and measurement circuitry receive the electrical feedback signal and detect and measure an amplitude of the electrical feedback signal to produce a second amplitude measurement value, the second amplitude measurement value being fed back to the controller circuitry and used by the controller circuitry to control an average power level of the laser; and
wherein the apparatus is capable of operating in a normal mode of operations and in a diagnostic mode of operations, and wherein in the normal mode of operations the second high-speed optical signal monitoring device is used for receiving optical feedback from the laser and said one or more bits correspond to one or more bits of an actual data stream being transmitted by the transceiver, and wherein in the diagnostic mode of operations the first high-speed monitoring photodiode is used for receiving light reflected by a break, a defect or a discontinuity in the transmit fiber and said one or more bits correspond to one or more bits of a bit pattern contained in the actual data stream.

7. The apparatus of claim 4, further comprising:
high-speed sampling circuitry configured to repeatedly sample the electrical modulation signal generated by the laser driver over time to obtain a plurality of samples and to construct an eye diagram from the samples; and
an eye monitor that displays the eye diagram generated by the sampling circuitry.

8. The apparatus of claim 7, further comprising:
a receive photodiode for receiving an optical signal transmitted on a receive optical fiber to the transceiver, the receive photodiode generating an electrical signal based on the received optical signal; and
a high-speed receive amplitude detector that receives the electrical signal generated by the receive photodiode and generates an electrical amplitude detection signal based on the received electrical signal, and wherein the high-speed sampling circuitry is configurable to repeatedly sample the electrical amplitude detection signal instead of or in addition to sampling the electrical modulation signal, wherein if the sampling circuitry repeatedly samples the electrical amplitude detection signal, the sampling circuitry constructs an eye diagram from the sampled electrical amplitude detection signal, and wherein the eye monitor displays the eye diagram constructed from the sampled electrical amplitude detection signal instead of or in addition to displaying the eye diagram constructed from the sampled electrical modulation signal.

9. The apparatus of claim 8, wherein said one or more aspects of signal quality in the network include one or more of bit error rate (BER), mask margin, jitter, rise and fall times, logic 1 level, logic 0 level, crossing level of rise and fall times, double tracing anomalies, and hits in an eye region of an eye diagram.

10. The apparatus of claim 1, wherein the high-speed amplitude detection and measurement circuitry includes a high-speed trans-impedance amplifier and a peak detector.

11. A method for obtaining signal measurements in a transceiver of an optical communications network, the method comprising:
in a laser driver of the transceiver, using an electrical modulation signal representative of one or more bits to amplitude modulate a laser to cause the laser to produce a modulated light beam that is launched into an end of an optical fiber;
in a first high-speed optical signal monitoring device of the transceiver, receiving a reflected portion of the light beam that has been reflected by a break, a defect or a discontinuity in the fiber and producing a first electrical signal based on the received reflected light;
in high-speed amplitude detection and measurement circuitry of the transceiver, receiving the first electrical signal produced by the monitoring device and processing the first electrical signal to detect and measure the amplitude of the first electrical signal to produce a first amplitude measurement value;
in laser controller circuitry of the transceiver, receiving the first amplitude measurement value, the laser controller circuitry controlling one or more components of the transceiver including at least the laser driver; and
in optical time-domain reflectometer (OTDR) circuitry of the transceiver, receiving the first amplitude measurement value from the laser controller circuitry and performing one or more OTDR algorithms to evaluate, based on the first amplitude measurement value, one or more aspects of signal quality in the network.

12. The method of claim 11, wherein one of said one or more OTDR algorithms includes a detection algorithm that processes the first amplitude measurement value to determine whether a break, a defect or a discontinuity exists in a transmit fiber in which the light produced by the laser is transmitted, wherein if the OTDR circuitry determines that a break, defect or discontinuity exists, the OTDR circuitry determines the distance of the break, defect or discontinuity from the transceiver.

13. The method of claim 12, further comprising:
using a bit pattern generator of the transceiver to generate a test bit pattern comprising said one or more bits and providing said one or more bits to the laser driver, the test bit pattern being received by the laser driver and used by the laser driver to generate the electrical modulation signal that is used to modulate the laser.

14. The method of claim 13, wherein the high-speed optical signal monitoring device is a high-speed monitoring photodiode capable of operating at a data rate of the transceiver.

15. The method of claim 14, wherein the transceiver is capable of operating in a normal mode of operations and in a diagnostic mode of operations, and wherein in the normal mode of operations, the first high-speed monitoring photodiode is used for receiving optical feedback from the laser and said one or more bits correspond to one or more bits of an actual data stream being transmitted by the transceiver, and wherein in the diagnostic mode of operations, the first high-speed monitoring photodiode is used for receiving light reflected by a break, a defect or a discontinuity in the transmit fiber and said one or more bits correspond to one or more bits of a bit pattern generated by the bit pattern generator.

16. The method of claim 14, further comprising:
in a second high-speed optical signal monitoring device of the transceiver, receiving a fraction of the light produced by the laser as optical feedback and producing an electrical feedback signal, and wherein the high-speed amplitude detection and measurement circuitry receive the electrical feedback signal and detect and measure an amplitude of the electrical feedback signal to produce a second amplitude measurement value, the second amplitude measurement value being fed back to the controller circuitry and used by the controller circuitry to control the laser driver; and
wherein the apparatus is capable of operating in a normal mode of operations and in a diagnostic mode of operations, and wherein in the normal mode of operations said one or more bits correspond to one or more bits of an actual data stream being transmitted by the transceiver, the second high-speed optical signal monitoring device being used in the normal mode of operations for receiving said fraction of the light produced by the laser as optical feedback and producing said electrical feedback signal, and wherein in the diagnostic mode of operations said one or more bits correspond to one or more bits of a bit pattern contained in the actual data stream, the first high-speed monitoring photodiode being used in the diagnostic mode of operations for receiving light reflected by a break, a defect or a discontinuity in the transmit fiber.

17. The method of claim 14, further comprising:
with high-speed sampling circuitry of the transceiver, repeatedly sampling the electrical modulation signal generated by the laser driver over time to obtain a plurality of samples and to construct an eye diagram from the samples; and
with an eye monitor, displaying the eye diagram generated by the sampling circuitry.

18. The method of claim 17, further comprising:
in a receive photodiode of the transceiver, receiving an optical signal transmitted on a receive optical fiber to the transceiver and generating an electrical signal based on the received optical signal; and
in a high-speed receive amplitude detector of the transceiver, receiving the electrical signal generated by the receive photodiode and generating an electrical amplitude detection signal based on the received electrical signal, and wherein the high-speed sampling circuitry is configurable to repeatedly sample the electrical amplitude detection signal instead of or in addition to sampling the electrical modulation signal, wherein if the sampling circuitry repeatedly samples the electrical amplitude detection signal, the sampling circuitry constructs an eye diagram from the sampled electrical amplitude detection signal, and wherein the eye monitor displays the eye diagram constructed from the sampled electrical amplitude detection signal instead of or in addition to displaying the eye diagram constructed from the sampled electrical modulation signal.

19. The method of claim 18, wherein said one or more aspects of signal quality in the network include one or more of bit error rate (BER), mask margin, jitter, rise and fall times, logic 1 level, logic 0 level, crossing level of rise and fall times, double tracing anomalies, and hits in an eye region of an eye diagram.

20. An apparatus for measuring signals in a transceiver of an optical communications network, the apparatus comprising:
a laser capable of being modulated to produce light;
a laser driver that generates an electrical modulation signal based on one or more bits of an actual data stream received by the laser driver, the laser driver modulating the laser with the electrical modulation signal to cause the laser to produce a modulated light beam that is launched into an end of a transmit fiber;
a first high-speed optical signal monitoring device that receives light impinging thereon and produces a first electrical signal based on the received light, at least a fraction of the received light corresponding to a portion of the light beam that has been reflected by a break, a defect or a discontinuity in the transmit fiber;
high-speed amplitude detection and measurement circuitry that receives the first electrical signal produced by the first optical signal monitoring device and detects and measures the amplitude of the first electrical signal to produce a first amplitude measurement value; and
optical time-domain reflectometer (OTDR) circuitry that receives the first amplitude measurement value and processes the first measurement value in accordance with one or more OTDR algorithms to evaluate, based on the first amplitude measurement value, one or more aspects of signal quality in the network.

21. The apparatus of claim 20, wherein said one or more bits are checked by circuitry of the apparatus to determine whether said one or more bits comprise a unique bit pattern that does not repeat often in the data stream, wherein if a determination is made that said one or more bits comprise a unique bit pattern, the OTDR circuitry performs a correlation algorithm to determine whether the first amplitude measurement value correlates to said one or more bits.

22. A method for obtaining signal measurements in a transceiver of an optical communications network, the method comprising:
in a laser driver of the transceiver, using an electrical modulation signal representative of one or more bits of an actual data stream to amplitude modulate a laser to cause the laser to produce a modulated light beam that is launched into an end of an optical fiber;
in a first high-speed optical signal monitoring device of the transceiver, receiving a reflected portion of the light beam that has been reflected by a break, a defect or a discontinuity in the fiber and producing a first electrical signal based on the received reflected light;
in high-speed amplitude detection and measurement circuitry of the transceiver, receiving the first electrical signal and and processing the first electrical signal to detect and measure the amplitude of the first electrical signal to produce a first amplitude measurement value; and
in optical time-domain reflectometer (OTDR) circuitry of the transceiver, receiving the first amplitude measurement value and performing one or more OTDR algorithms to evaluate, based on the first amplitude measurement value, one or more aspects of signal quality in the network.

23. The method of claim 22, wherein said one or more bits are checked by circuitry of the apparatus to determine whether said one or more bits comprise a unique bit pattern that does not repeat often in the data stream, wherein if a determination is made that said one or more bits comprise a unique bit pattern, the OTDR circuitry performs a correlation algorithm to determine whether the first amplitude measurement value correlates to said one or more bits.
